(19) United States
(12) Patent Application Publication
(10) Pub. No.: US 2025/0124467 A1
(43) Pub. Date: Apr. 17, 2025

(54) METHOD, SYSTEM, AND STORAGE MEDIUM FOR DYNAMIC AND LAYERED PROMOTION STRATEGY

(71) Applicant: R&D CO-OP, INC., LOS ANGELES, CA (US)

(72) Inventor: Kenna Zemedkun, Los Angeles, CA (US)

(21) Appl. No.: 18/486,787

(22) Filed: Oct. 13, 2023

(51) Int. Cl. G06Q 30/0251; G06Q 30/0601

(52) U.S. Cl. CPC G06Q 30/0253; G06Q 30/0609; G06Q 30/0615; G06Q 30/0633

(57) ABSTRACT

A method for dynamic and layered promotion involves utilizing a layered promotion model system having a seller device, a buyer device, a peer device, and a system server. The seller device provides a zero party dataset representing values of the seller and a nomination dataset representing a proposed nuclear network. The system server receives these datasets and creates a zero layer dataset and a first layer dataset therefrom. The at least one system server then analyzes these datasets to derive search criteria and value lists. Based on these criteria, the at least one system server selects accepted peers from the first layer dataset. An authorized programmatic product is created using the selected peers, and which represents a packaged audience reach. The seller can customize the terms of communication in the authorized programmatic product. The buyer can place an order for the authorized programmatic product, limited by the specified communication terms.

### FIELD

The present disclosure relates to a layered promotion model for modern brand promotion and, more particularly, a layered promotion model method and system that permits talents and brands to magnify reach and engagement with many audiences.

### INTRODUCTION

This section provides background information related to the present disclosure which is not necessarily prior art.

Historical approaches to promoting products or services have typically involved static and one-dimensional advertising methods, such as television commercials, print advertisements, and online banner ads. These traditional advertising methods often lacked personalization and fail to effectively target specific audiences. Additionally, these approaches did not provide a means for companies to directly engage with potential buyers or leverage the influence of their peers.

More recently, there have been attempts to incorporate data-driven advertising techniques, such as programmatic advertising, which uses algorithms to automate the buying and selling of ad inventory. However, these approaches have often had to rely on third-party data and lacked the ability to truly capture the unique value system of the company or leverage the power of peer networks.

Another approach that has been explored is influencer marketing, where companies collaborate with individuals who have a large following on social media platforms. While this approach allows for more targeted promotion and the use of peer influence, it often lacks a systematic and scalable framework for identifying and engaging with the most relevant peers.

Even more recently, the dynamics between talents and brands have evolved to incorporate project-based collaborations as a pivotal strategy. Talents such as artists, actors, musicians, athletes, and influencers in general are often paid to represent companies or their brands by promoting products, appearing in videos and commercials, offering reviews of products, attending events, and participating in a variety of other marketing endeavors. Typically, a more famous person can reach a wider audience, and will likewise be paid more than a person who is less well known. For some, identity is a significant asset, worth millions of dollars.

These collaborations between talents and brands encompass a wide range of marketing channels, including Branded Content, Creative Direction, Event Sponsorship, and more. While these avenues hold substantial potential for brand promotion, a critical challenge persists: the need to optimize audience penetration and engagement. Existing approaches, primarily relying on direct engagement or influencer-based models, do demonstrate effectiveness in achieving these goals for many brands. However, their scalability and capacity for precise audience targeting leave significant room for improvement.

The effectiveness of brand marketing often hinges on the ability to resonate with and engage target audiences. This is because consumer attention is usually fragmented across various media and platforms. For this reason, the importance of achieving high levels of audience penetration and engagement cannot be overstated. Brands that understand this fragmented nature of consumer attention will typically aim not only to reach a broad audience but also to foster meaningful connections that result in lasting brand loyalty. Consequently, there is an ongoing demand within the industry for innovative solutions that can enhance the efficiency of audience engagement strategies.

Currently, brand promotion strategies predominantly rely on two primary methods: direct engagement and influencer-based models. Direct engagement often involves brands interacting with their audience through social media, advertising campaigns, and other direct communication channels. Influencer marketing, on the other hand, leverages the reach and credibility of individuals with substantial social media followings to promote products and services. While both methods have their merits, they encounter significant limitations in terms of scalability and precise audience targeting.

Direct engagement strategies, while effective in establishing brand presence, often lack the ability to reach a vast and diverse audience. Moreover, their impact can be challenging to quantify and optimize, making it difficult to allocate resources efficiently. As a result, many brands find it challenging to scale their engagement efforts without compromising on quality and effectiveness.

Influencer-based marketing models have gained prominence due to their potential for reach and engagement. However, they too face limitations, particularly in the context of nuanced audience targeting. Influencers may have diverse follower demographics, and their endorsements may not always align perfectly with the values or goals of a brand. Consequently, while influencer marketing can yield positive results, it often falls short in terms of precision and scalability.

Existing marketing strategies also make it difficult for an artist, talent, or content creator to maintain agency over their right of publicity, as well as control over specific networks of contacts affiliated with the artist and content creator. Many people affiliate themselves with, or imitate the likeness of, talents such as popular artists, actors, musicians, and athletes, as examples. By reusing content created by these talents, such imitators can sometimes reach a large audience, occasionally large enough to catch the attention of brands.

Furthermore, talents being imitated or appropriated by others in this way often do not give permission for these others to profit from their imitation or appropriation. The original talents can lose control over their likeness, and even miss out potential marketing opportunities when brands pursue someone else they perceive as affiliated with the talent for a lesser price. Alternatively, artists may inadvertently be associated with a product or brand they do not wish to support. It would be preferable for the artist, talent, or content creator to instead interact directly with potential brands so that the artists and content creators might have greater control and explicitly approve any access to their specific network of contacts.

It has also proved difficult for artists, actors, musicians, athletes, and the like to monetize their social media contacts and the audience affiliated with those contacts. Generally, it may become more and more difficult to maintain agency over who may be considered a close contact or affiliate for purposes of marketing and brand building. Artists, musicians, and athletes often do not have direct correspondence with brands and companies that are interested in paying for promotion of their products.

Recognizing the shortcomings of current brand promotion methods, there exists a compelling opportunity to develop innovative solutions that maximize audience penetration and engagement. There is a continuing need for a novel approach that transcends the limitations of direct engagement and influencer-based models, enabling brands to achieve unprecedented levels of scalability and precision in reaching and captivating their target audiences. Desirably, the novel approach will revolutionize brand marketing and elevate the effectiveness of project-based collaborations between talents and brands in the modern landscape by harnessing the power of emerging technologies and data-driven insights.

None of the aforementioned approaches have provided a comprehensive solution that combines the features described in this disclosure.

Accordingly, there is a continuing need for a system and method that allows a seller such as an artist, talent, or content creator to create and maintain agency over their right of publicity and one or more specific networks of contacts affiliated with the seller. Ideally, the seller may interact directly with a potential buyer such as a brand and explicitly approve any access by the buyer to their specific network of contacts.

### SUMMARY

In concordance with the instant disclosure, a system and method that allows a seller such as an artist, talent, or content creator to create and maintain agency over their right of publicity and one or more specific networks of contacts affiliated with the seller, and which allows the seller to interact directly with a potential buyer such as a brand and explicitly approve any access by the buyer to their specific network of contacts, have been surprisingly discovered.

In some embodiments, the method and system of the present disclosures introduces a model for dynamic and layered promotion that leverages a source layer based on talent/seller-determined criteria dataset, a first layer involving a nuclear network of peers of the talent/seller, and a second layer including cohorts in an extended network such as social media influencers who are not peers but whom otherwise have alignment in values with the talent/seller. By utilizing this dynamic model, the method and associated system enables personalized and targeted promotion by a company/brand/buyer that aligns with the value system of the seller and leverages the influence of their nominated peers and cohorts.

In one embodiment, a method for dynamic and layered promotion includes a step of providing a layered promotion model system. The layered promotion model system has a seller device, a buyer device, a peer device, and a system server.

The seller device of the layered promotion model system has a seller device human interface, a seller device memory, a seller device processor, and a seller device display. The seller device human interface is configured for use by a seller and for providing a zero party dataset and a nomination dataset. The zero party dataset includes a seller-determined criteria dataset representing a value system of the seller. The nomination dataset represents a plurality of peers proposed by a seller as forming a nuclear network of the seller. The nomination dataset also includes descriptions and biographies associated with each of the plurality of peers.

The buyer device of the layered promotion model system has a buyer device human interface, a buyer device memory, a buyer device processor, and a buyer device display. The buyer device human interface is configured for use by a buyer and for placing an authorized programmatic product order.

The peer device of the layered promotion model system has a peer device human interface, a peer device memory, a peer device processor, and a peer device display, the peer device human interface configured for use by at least one nominated peer and for accepting a nomination request to be included in the nomination dataset.

The at least one system server of the layered promotion model system has a system server memory and a system server processor. The at least one system server is in communication with the seller device, the buyer device, the peer device, and at least one third party server, for example, through a wide area network such as the internet. The at least one third party server has at least one third party dataset. The system server memory stores a plurality of modules including tangible, non-transitory processor executable instructions. The plurality of modules include a zero layer data gathering module, a zero layer creation module, a first layer nominating module, a first layer data gathering module, a first layer creation module, a zero layer data analysis module, a first layer data analysis module, a criteria derivation module, an authorized programmatic product creation module, a communication agreement and message forms module, and an order placement module.

The method includes a step of receiving, by the zero layer data gathering module of the at least one system server from the seller device, the zero party dataset and the nomination dataset. The method also includes a step of creating, by the zero layer creation module of the at least one system server, a zero layer dataset based on the zero party dataset. The zero layer dataset represents an identity archetype of the seller. The method further includes a step of communicating, by the first layer nominating module of the at least one system server to the peer device, the nomination request for at least one nominated peer of the plurality of peers. The nomination request includes a communication to the at least one nominated peer asking for an acceptance of the nomination request to be included in a first layer dataset representing the nuclear network of the seller.

The method further includes a step of receiving, by the first layer data gathering module of the at least one system server from the peer device, the acceptance of the nomination request by the at least one nominated peer of the plurality of peers. The at least one nominated peer becomes and is stored in the at least one system server as an at least one accepted peer upon receipt of the acceptance. The method also includes a step of creating, by the first layer creation module of the at least one system server, the first layer dataset. The first dataset includes an identification of the at least one accepted peer.

The method also includes steps of analyzing, by the zero layer data analysis module of the at least one system server, the zero layer dataset to provide an analyzed zero layer dataset, and also analyzing, by the first layer data analysis module of the at least one system server, the first layer dataset to provide an analyzed first layer dataset. The method then generates, by the criteria derivation module of the at least one system server from the analyzed zero layer dataset and the analyzed first layer dataset, an anonymized search criteria dataset and a value list dataset of the seller. The method then provides a step of selecting on a basis of the anonymized search criteria dataset and the value list dataset the at least one accepted peer of the plurality of peers in the first layer dataset that meet a predetermined alignment threshold for the seller.

Subsequent to these steps, the method also includes a step of creating, by the authorized programmatic product creation module of the at least one system server from the anonymized search criteria dataset and the value list dataset, an authorized programmatic product. The authorized programmatic product represents a packaged audience reach that is enriched through the selection of the at least one accepted peer of the plurality of peers that meets the predetermined alignment threshold for the buyer.

The method then permits, by the communication agreement and message forms module of the at least one system server, the seller to at least one of authorize, amend, and add terms of messages and forms of communication to be specified in the authorized programmatic product. The method also provides a step of receiving, by the order placement module of the at least one system server from the buyer device, the authorized programmatic product order. Following receipt of the authorized programmatic product order, the method also provides a step of transmitting, by the order placement module of the at least one system server, to the buyer device the authorized programmatic product order. The buyer is thereby provided with the authorized programmatic product representing the nuclear network of the seller, which has been limited according to the terms of the messages and the forms of communication specified by the seller.

In another embodiment, the system for implementing the aforementioned method is provided.

In a further embodiment, a non-transient computer-readable storage medium comprising instructions being executable by one or more processors to perform the aforementioned method is provided.

In a particular embodiment, the method and system allow for a more dynamic and layered promotion strategy. Brands can engage not just with a Source (Layer-0) but also with a Nuclear Network (Layer-1) of individuals nominated by the talent, as well as a wider network (Layer-2) of individuals and influencers identified through influencer management platforms. The method and system combine first-party information gathered during onboarding from Layer-0 and Layer-1 to form a set of search criteria. Anonymized search criteria and values are then used to retrieve the most aligned individuals from Layer-2. This creates a rich pool of candidates for relaying intended messages and deliverables.

Advantageously, the method and system of the present disclosure provides a paradigm shift in how talents and brands can harness the power of layered networks to magnify their reach and engagement. The method and system allow for the seller-controlled relay of communication to a combined reach of Level 0, Level 1, and Level 2 audiences, providing a versatile and efficient approach to modern brand promotion.

In an exemplary embodiment, the method, system, and associated computer readable storage medium may be configured for creating a nuclear network of a seller accessible to a buyer, in accordance with one or more embodiments. The method may include a device having a human interface for inputting seller-determined criteria, a memory on which processor executable instructions being stored, a processor in communication with the human interface and the memory, and a display for displaying the nuclear network by a system server, the at least one system server configured for analyzing the seller-determined criteria and for generating the nuclear network, the at least one system server in communication with the device through a wide area network. The method may include permitting a seller, by human interface of the device, to input the seller-determined criteria. The method may include transmitting the seller-determined criteria from the device to the at least one system server. The method may include creating, by the at least one system server, a nuclear network based on seller-determined criteria. The method may include transmitting the nuclear network from the at least one system server to the device through the wide area network. The method may include generating a display of the nuclear network on the display of the device, the display of the network accessible to the buyer. The method may include providing, by the device, information to the seller regarding the nuclear network and allowing for seller feedback and management of the seller-determined criteria and the nuclear network.

In operation, the seller may evaluate opportunities for authentically partnering with the buyer that have varying commitments of time and energy. The seller may choose to be directly involved, indirectly involved, or both. Likewise, the buyer may engage the seller at varying levels with respect to price for promotional and other services. More specifically, the seller may decide to work directly with a buyer and/or provide access to one or more networks such as a nuclear network and/or an expanded network, as non-limiting examples, as determined by the seller. The seller may create one or both of the nuclear network and the expanded network and receive variable compensation depending on whether the seller participates directly with the buyer or simply permits the buyer to have access to one or both of the nuclear network or the expanded network.

The seller may create the nuclear network by selecting a desired number of contacts and/or affiliates and forming a group of the selected contacts. Contacts may include social media contacts, email contacts, and in-person contacts, as non-limiting examples. Any person that may promote a product, service, or event, as non-limiting examples, in any capacity on behalf of the seller may be a contact included in the nuclear network. Access to the nuclear network may include specific information about each contact selected, such as information relating to communicating with each contact, as determined by the seller and/or the contact, or as negotiated between the seller and the buyer. The buyer may be permitted to communicate with each contact directly, according to certain embodiments. Alternatively, the nuclear network may include a list of contact names, and the seller may communicate with each contact included in the nuclear network directly on behalf of the buyer.

The seller may also subjectively select contacts that the seller believes closely represent the seller's brand and/or public or private persona to form the nuclear network, as determined by the seller. The seller may also employ other or additional means for formulating the nuclear network. For example, pre-determined algorithms may be used to determine the contacts for the nuclear network and/or may provide insight that help the seller determine which contacts to include in the nuclear network. In one non-limiting example, a combination of forced multipliers based on pre-determined data sets may be used to create the nuclear network. In certain embodiments, data provided by pre-determined algorithms and/or third parties, subjective first party data provided by the seller, or any combination of data may be used to form the nuclear network, as determined by the seller. The seller, according to certain embodiments, may be able to include specific data sets when creating the nuclear network, as desired. Certain data sets may be required for formulation of the nuclear network, according to certain embodiments.

The seller may further create the expanded network by selecting contacts and forming a group of the selected contacts. Contacts may include social media contacts, email contacts, and in-person contacts, as non-limiting examples. Any person that may promote a product, service, or event, as non-limiting examples, in any capacity on behalf of the seller may be a contact included in the expanded network. Access to the expanded network may include specific information about each contact selected, such as information relating to communicating with each contact, as determined by the seller and/or the contact, or as negotiated between the seller and the buyer. The buyer may be permitted to communicate with each contact directly, according to certain embodiments. Alternatively, the expanded network may include a list of contact names, and the seller may communicate with each contact included in the expanded network directly on behalf of the buyer.

Additionally, the seller may subjectively select contacts that the seller believes represent the seller's brand and/or public or private persona to form the expanded network, as determined by the seller. The seller may also employ other or additional means for formulating the expanded network. For example, pre-determined algorithms may be used to determine the contacts for the expanded network and/or may provide insight that help the seller determine which contacts to include in the expanded network. In one non-limiting example, a combination of forced multipliers based on pre-determined data sets may be used to create the expanded network. In certain embodiments, data provided by pre-determined algorithms and/or third parties, subjective first party data provided by the seller, or any combination of data may be used to form the expanded network, as determined by the seller. The seller, according to certain embodiments, may be able to include specific data sets when creating the expanded network, as desired. Certain data sets may be required for formulation of the expanded network, according to certain embodiments.

The seller may further select any desired number of contacts to form the nuclear network. In certain more particular embodiments, the seller may select less than one hundred contacts to form the nuclear network. Likewise, the seller may select any desired number of contacts for the expanded network. In certain more particular embodiments, the seller may select less than one thousand contacts for the expanded network. In certain embodiments, the expanded network may include the network of each contact that is included in the nuclear network, as one non-limiting example. Alternatively, the expanded network may include contacts selected by the seller that are not included in the nuclear network. In certain embodiments, one or more contacts included in the nuclear network may also be included in the expanded network, and vice versa.

The seller may make changes to one or both of the nuclear network and the expanded network including adding and removing certain contacts and/or affiliates, as one non-limiting example, at any time. The seller may have various nuclear networks representing one or more categories. As one non-limiting example, a seller working as an actor and a musician may have a nuclear network for contacts in the music industry, a nuclear network for contacts in the acting industry, and a nuclear network for non-profit contacts. The seller may also create nuclear networks based on differing criteria such as optimal monetization or optimal outreach, as non-limiting examples.

The buyer may engage the seller directly, or may compensate the seller in exchange for access to one or more nuclear and/or expanded networks. The buyer may also compensate the seller for direct promotional and/or other services in addition to access to one or more nuclear and/or expanded networks. Compensation may vary depending on whether the seller is directly involved and may be negotiated by the seller and the buyer. Non-limiting examples of promotional and other services include social media posts, in-person appearances, promotional videos, and reposting of social media content by one or more of the seller, the nuclear network, and the expanded network.

The seller may further create a personal webpage or other promotional tool detailing their nuclear network and/or expanded network. Accordingly, the buyer may be capable of seeing the nuclear and expanded networks, including objective and subjective data relating to the nuclear and expanded networks in order to evaluate whether to initiate contact with the seller. The seller and/or the seller's contacts may determine what the buyer can see with respect to each of the nuclear network and the expanded network. Examples may include first party data for one or both of the seller and the seller's contacts such as a list of brands the seller and/or contacts represents, information about industries the seller and/or contacts are actively involved with, geographic information, personal information relating to interests, hobbies, personality and attitudes, talent, skills, experience, experience within specified industries, past projects, objective and subjective measures of past and present success, background, opinions, demographics, or any other desired data in the form of survey, personal essay, endorsements from other sellers, buyers or third parties, or any other suitable means. The seller and or the seller's contacts may also include and/or input desirable syntax, editorial, and psychographic data as well in. Subjective and objective data collected from third parties may also be included. According to certain examples, social data from one or more outside platforms and other varied data resources may also be included with respect to the seller and/or the seller's contacts included in one or both of the nuclear network and the expanded network. As another non-limiting example, binomial data may also be included.

Also, the seller may present the buyer with information relating to opportunities for the buyer to be involved directly with the seller and/or indirectly using the seller's nuclear network and/or expanded network. Information may include the seller's availability, compensation requirements, target audience, and any other suitable information. Additional information may include a list of contacts within a nuclear network and/or expanded network, compensation requirements, target audience, and any other suitable information with respect to the available networks.

In particular examples, the two sided marketplace may be used by one or both of the seller and the buyer. The buyer may express interest in certain projects relating to the seller and/or initiate communication with the seller regarding upcoming projects. Likewise, the seller may reach out to the buyer about upcoming projects advertised by the buyer. In certain embodiments, the buyer, such as a brand, may include information about the brand and/or specific opportunities available from the buyer that the seller may express interest in. The buyer may also indicate what the buyer is looking for in general or for specific opportunities. In one non-limiting example, the buyer may indicate they are looking for access to a nuclear network to help promote a product or service. The buyer may inform the seller about the buyer in order to optimize potential partnerships. Information such as compensation and/or target audience, as non-limiting examples, may be provided.

In yet other examples, an invite-only platform or website may be used by the seller and the buyer, according to certain embodiments. One or both of the seller and the buyer may be invited to participate, or may pay a fee or subscription to participate. In certain embodiments, the platform may be free to pre-approved sellers and buyers meeting certain criteria. Access to the platform may vary for sellers and buyers depending on fees, subscriptions, pre-approval processes, affiliation with other sellers and/or buyers, or any other suitable measure. A service fee may be collected from one or both of the seller and the buyer for partnerships formed and or fulfilled using the platform or website. The platform may function in place of or in combination with third party talent representatives, attorneys, banks or other money-transferring agencies, vendors, and related business brokers. The platform may include standard agreements for use by the sellers and the buyers such as MSA and SOW documents, as non-limiting examples. Management teams may use the platform for internal organization and communication with respect to the seller, the buyer, and past, present, and future projects. Sellers and buyers may use the platform as CRM technology for managing all aspects of business.

Advantageously, the expense and hassle of subjective, limited, and unreliable third parties may be minimized, and the sellers and buyers may act on their own behalf. Sellers and buyers may engage in communication and exchange of services and compensation in a most efficient, cost-effective manner. In one more particular example, it is possible to use a platform such as the one described in applicant's co-owned U.S. Provisional Patent Application No. 63/415,849, on Oct. 13, 2022, and titled METHODS, SYSTEMS, AND STORAGE MEDIA FOR MATCHING A SELLER AND A BUYER, the entire disclosure of which is hereby incorporated herein by reference. It should be appreciated that any other suitable platform may be used, as determined by one of skill in the art.

It should be understood that the seller may be invited and/or vetted by a predetermined group of individuals, businesses, and/or peers, as non-limiting examples. Likewise, the seller may be invited and/or vetted using predetermined criteria based on selected data points or other objective or subjective information. The buyer may be invited to participate based on a record of or commitment to spending relating to product placement, talent sponsorship, sales, and any other suitable categories. According to certain embodiments, direct communication between the seller and the buyer may advantageously facilitate optimal and efficient partnerships, foster more meaningful relationships, improve communication and negotiations, and result in more lucrative and fulfilling outcomes for the seller and the buyer.

Advantageously, the buyer will have access to one or both of the seller and seller's contacts via the seller's nuclear network and expanded network. This provides the seller with additional opportunities to be involved, either directly or indirectly, with the buyer, and at varying price points. Additionally, the seller has agency over which contacts and affiliates represent the seller, and the seller is able to monetize those contacts.

It is further believed advantageous that the nuclear and expanded networks are an authentic representation of seller, as the contacts were selected and/or approved by the seller, and the seller is able to monetize those contacts. The buyer, advantageously, is able to market products and services using a more authentic representation of the seller. The seller has agency over their promotional opportunities, direct or indirect, and the relationship between the seller and the buyer is optimized.

Further areas of applicability will become apparent from the description provided herein. The description and specific examples in this summary are intended for purposes of illustration only and are not intended to limit the scope of the present disclosure.

### DRAWINGS

The drawings described herein are for illustration purposes only and are not intended to limit the scope of the present disclosure in any way.

FIGS. 1A and 1B illustrate a system configured for dynamic and layered promotion, according to one embodiment of the present disclosure.

FIGS. 2A, 2B, 2C, and 2D illustrate a method for dynamic and layered promotion, according to one embodiment of the present disclosure.

FIG. 3 is a schematic illustration of a layered promotion model for use with the system of FIGS. 1A and 1B, and for use with the method of FIGS. 2A, 2B, 2C, and 2D, according to one embodiment of the present disclosure.

FIG. 4 is a schematic illustration describing a process executed according to the method of FIGS. 2A, 2B, 2C, and 2D, including formation of an authorized programmatic audience and using means for audience enrichment.

FIG. 5 is a schematic illustration describing a process engagement of the authorized programmatic audience and having a seller-controlled or authorized programmatic relay.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The present technology improves the process of providing a seller with opportunities and agency with respect to evaluating and selecting potential marketing opportunities offered by a buyer. The seller may be an athlete, musician, artist, or any other person in the public eye capable of reaching a large audience, as non-limiting examples, and the buyer may be a brand or organization looking to hire the seller to promote products and/or services. More specifically, according to certain embodiments, the present technology may offer the seller tools that may be used to directly offer seller promotional or other services to the buyer, access to a nuclear network of contacts and/or affiliates that the seller has selected as representative of the seller, access to an expanded network of contacts affiliated with the seller and/or the nuclear network of the seller, and any combination thereof. Advantageously, the seller has direct contact with the buyer to negotiate the value of the seller, the seller's nuclear network, and/or the seller's expanded network as a marketing tool. The seller may more effectively monetize their own time and talent, and additionally find ways to leverage and monetize close contacts and affiliates, while maintaining more agency with respect to their personal brand as a public figure.

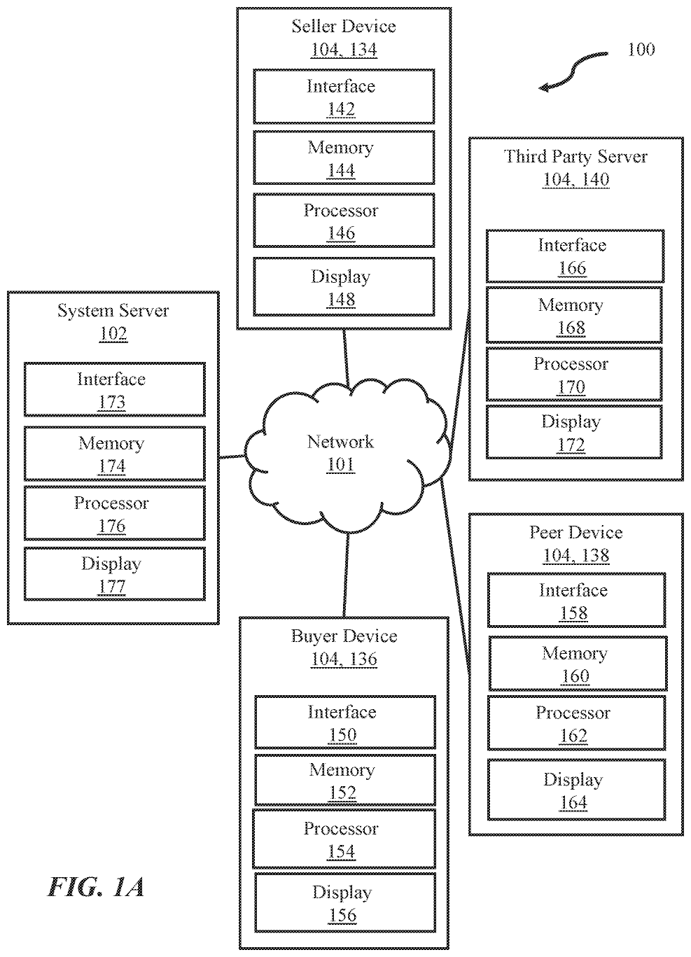

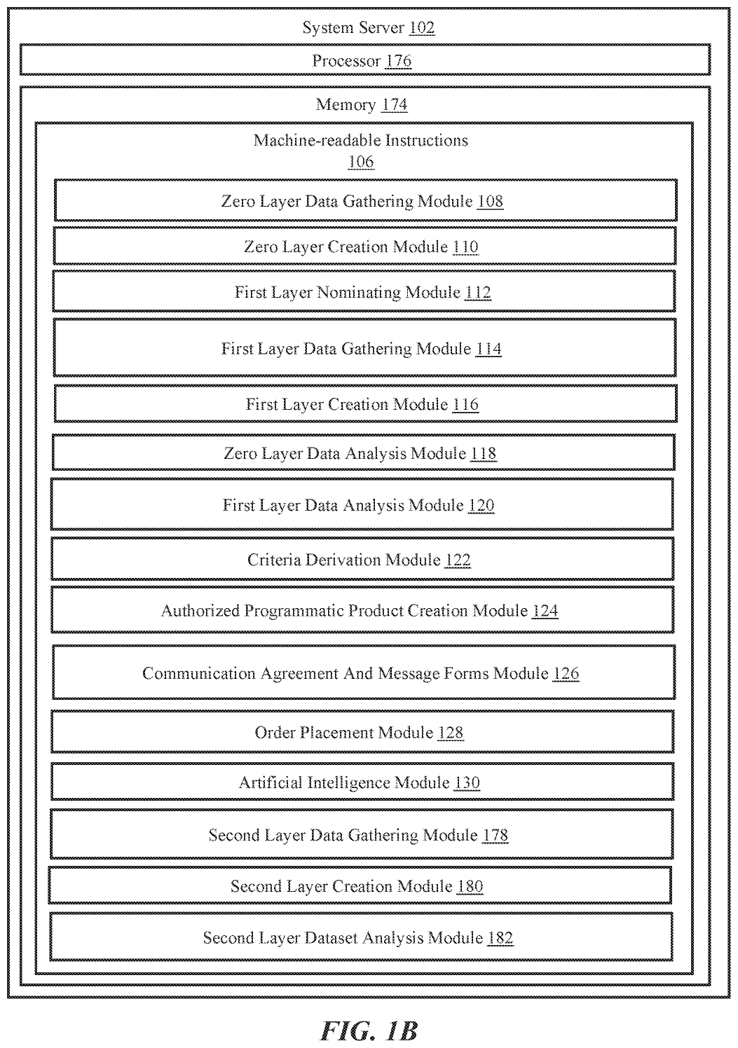

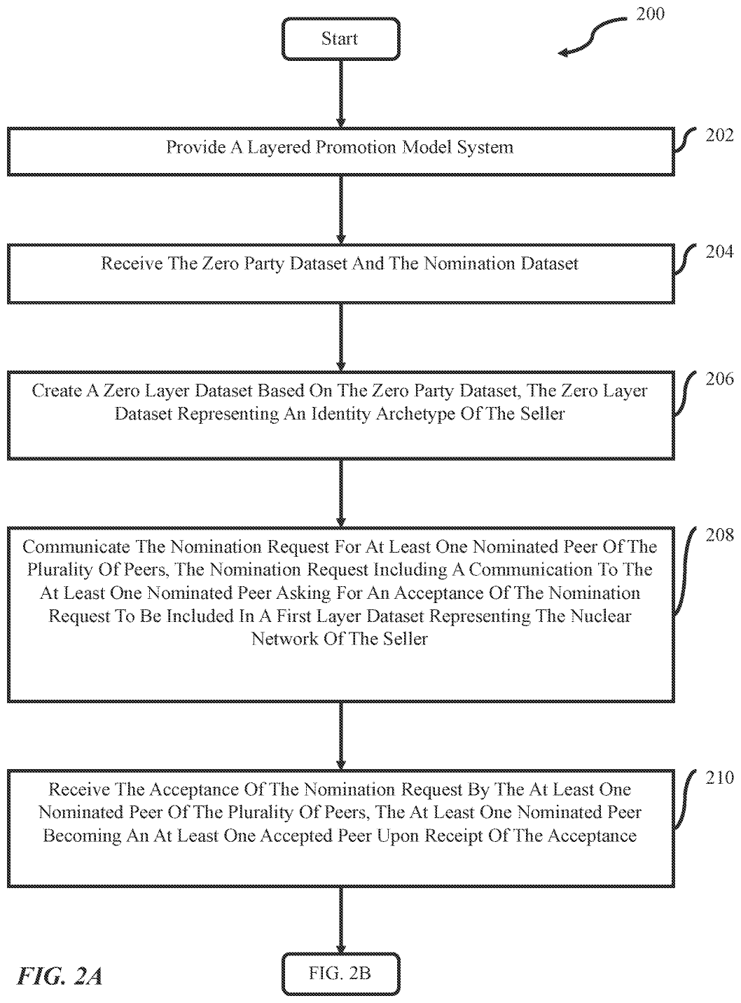

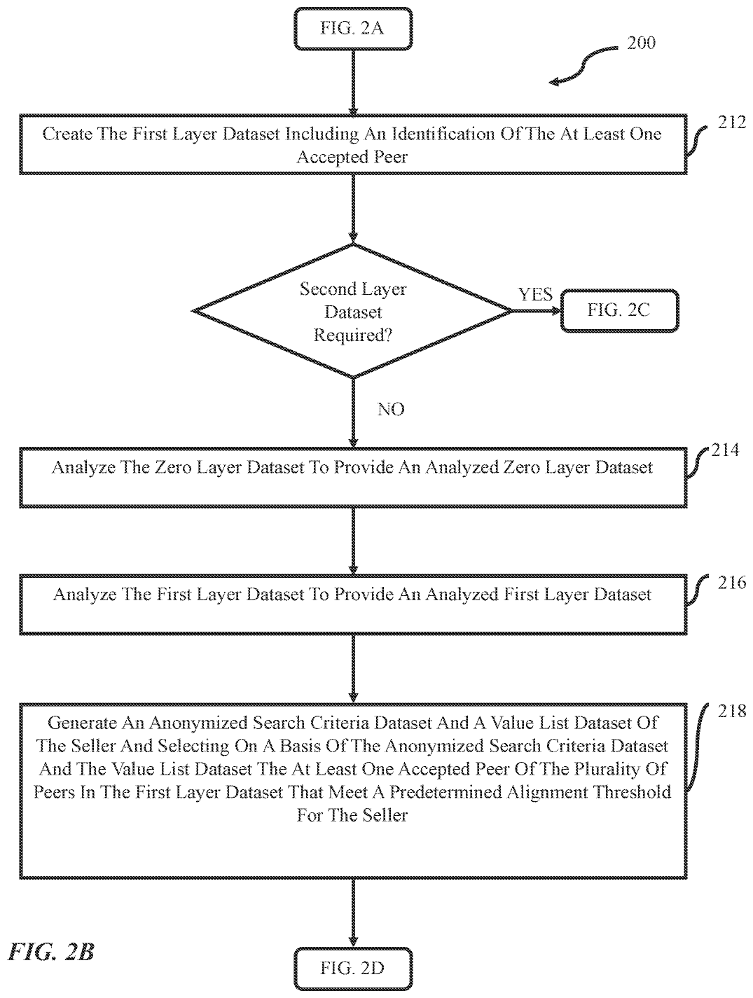

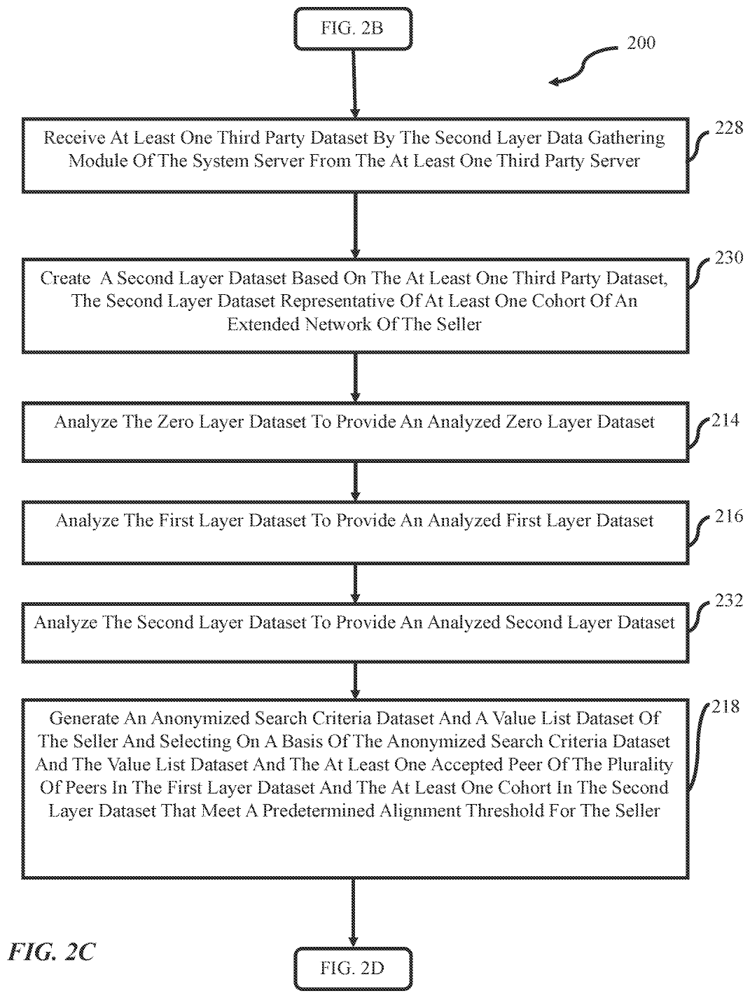

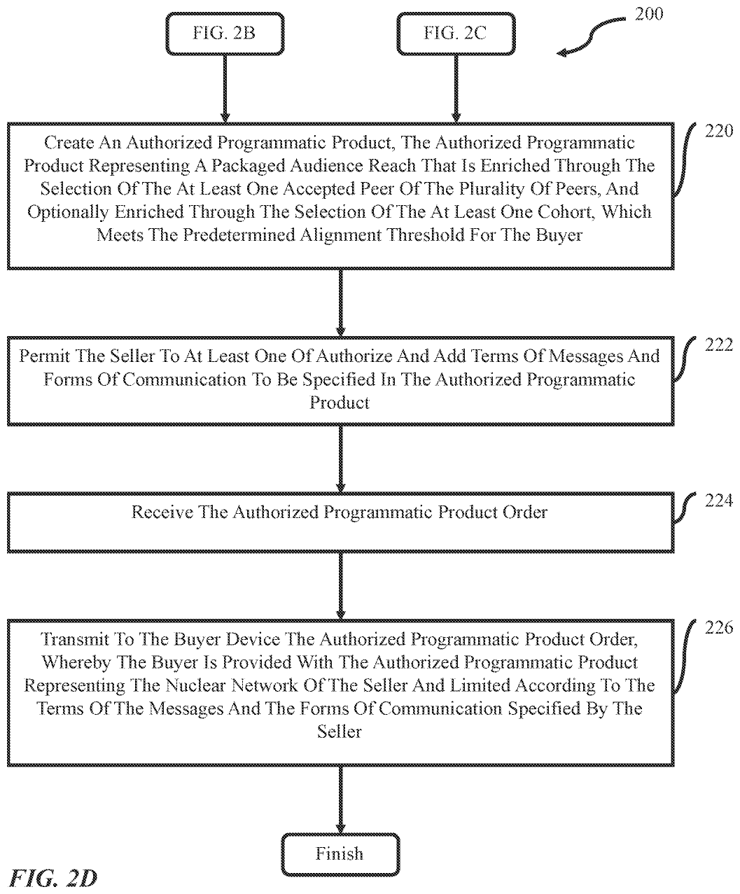

FIGS. 1A and 1B illustrate a system 100 configured for dynamic and layered promotion, for example, by a method 200 as shown in FIGS. 2A to 2D, and in accordance with one or more embodiments. In some cases, the system 100 may include a one or more computing platforms in the form of at least one system server 102. The at least one system server 102 may be communicably coupled with a plurality of remote platforms 104, for example, via at least one network 101. In some cases, users may access the system 100 via the plurality of remote platforms 104. It should be appreciated that, depending on the situation, the at least one system server 102 may therefore be provided as either a standalone system or a distributed system with the steps distributed across more than one platform.

In some cases, the one or more computing platforms 102, may be communicatively coupled to the remote platforms 104. In some cases, the communicative coupling may include communicative coupling through a networked environment such as the at least one network 101. The networked environment may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platforms 104 may be operatively linked via some other communication coupling. The one or more computing platforms 102 may be configured to communicate with the at least one network 101 via wireless or wired connections. In addition, in an embodiment, the system 100 may also include one or more hosts or servers, such as the at least one system server 102 connected to the network 101 through wireless or wired connections. According to one embodiment, the at least one system server 102 may be implemented in or function as base stations (which may also be referred to as Node Bs or evolved Node Bs (eNBs)). In other embodiments, the at least one system server 102 may include web servers, mail servers, application servers, etc. According to certain embodiments, the at least one system server 102 may be standalone servers, networked servers, or an array of servers. In an embodiment, the plurality of remote platforms 104 may be configured to communicate directly with each other via wireless or wired connections. Examples of the plurality of remote platforms 104 may include, but is not limited to, smartphones, wearable devices, tablets, laptop computers, desktop computers, Internet of Things (IoT) devices, or other mobile or stationary devices.

Referring again to FIGS. 1A and 1B, the at least one system server 102 may be configured by machine-readable instructions 106. The machine-readable instructions 106 may include modules. In this aspect, the method 200 as shown in FIGS. 2A to 2D may be configured to be implemented by the modules, which in turn may be implemented as one or more of functional logic, hardware logic, electronic circuitry, software modules, and the like.

As illustrated in FIGS. 1A and 1B, the modules may include one or more of a zero layer data gathering module 108, a zero layer creation module 110, a first layer nominating module 112, a first layer data gathering module 114, a first layer creation module 116, a zero layer data analysis module 118, a first layer data analysis module 120, a criteria derivation module 122, an authorized programmatic product creation module 124, a communication agreement and message forms module 126, an order placement module 128, an artificial intelligence module 130, and/or other modules.

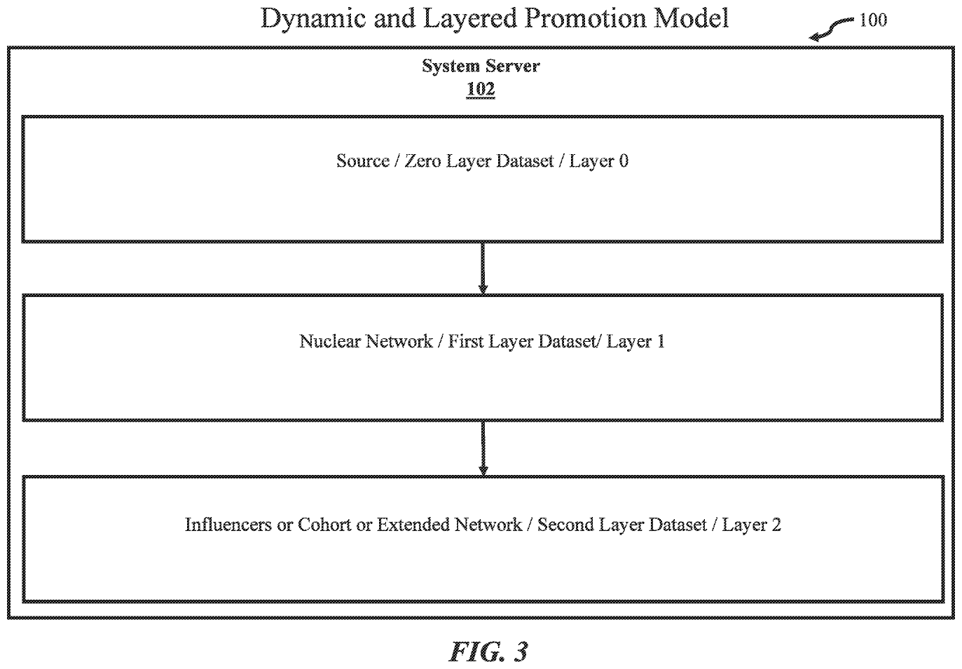

In particular, and according to various embodiments of the present disclosure, the at least one system server 102 may constitute a layered promotion model system involving a layered promotion model, for example, as illustrated schematically in FIG. 3. The plurality of remote platforms 104 may include a seller device 134, a buyer device 136, a peer device 138, and at least one third party server 140, for example. One of ordinary skill in the art may also select suitable types of hardware for each of the seller device 134, the buyer device 136, the peer device 138, and the at least one third party server 140, as well as additional computer devices (not shown), within the scope of the present disclosure.

As shown in FIGS. 1A and 1B, the seller device 134 may have a seller device human interface 142, a seller device memory 144, a seller device processor 146, and a seller device display 148. The seller device human interface 142 may be configured for use by a seller and for providing a zero party dataset and a nomination dataset. The zero party dataset may include a seller-determined criteria dataset that represents a value system of the seller. The nomination dataset represents a plurality of peers proposed by a seller as forming a nuclear network (shown in FIG. 3) of the seller. The nomination dataset may further include peer details such as descriptions and biographies associated with each of the plurality of peers. One of ordinary skill in the art may also select other suitable data or information to include each of the zero party dataset and the nomination dataset, as desired.

The buyer device 136 has a buyer device human interface 150, a buyer device memory 152, a buyer device processor 154, and a buyer device display 156. The buyer device human interface 150 is configured for use by a buyer and for placing an authorized programmatic product order, as is described further herein.

With continued reference to FIGS. 1A and 1B, the peer device 138 has a peer device human interface 158, a peer device memory 160, a peer device processor 162, and a peer device display 164. The peer device human interface 158 is configured for use by at least one nominated peer and for accepting a nomination request to be included in the nomination dataset, as also described further herein.

The at least one third party server 140 may have a third party server human interface 166, a third party server memory 168, a third party server processor 170, and a third party server display 172. The at least one third party server 140 has at least one third party dataset. The at least one third party server human interface 166 is configured for use by a third party, such as a least one of a social media platform and an influencer, as is described further herein.

As shown in FIGS. 1A and 1B, the at least one system server 102 further may have a system server human interface 173, a system server memory 174, a system server processor 176, and a system server display 177. The at least one system server 102 is in communication with the seller device 134, the buyer device 136, the peer device 138, and at least one third party server 140 through the network 101, as described hereinabove.

It should be appreciated that the server memory 174 of the at least one system server may further include or be coupled to a memory (internal or external), which may be coupled to one or more processors such as the system server processor 176, for storing information and instructions that may be executed by the system server processor 176. The system server memory 174 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, the system server memory 174 can consist of any combination of random-access memory (RAM), read only memory (ROM), static storage such as a magnetic or optical disk, hard disk drive (HDD), or any other type of non-transitory machine or computer readable media. The instructions stored in the system server memory 174 may include program instructions or computer program code that, when executed by the system server processor 176, enable the at least one system server 102 to perform tasks as described herein.

One skilled in the art will also appreciate that one or more processors such as the system server processor 176 of the at least one system server 102 may be configured for processing information and executing instructions or operations. The system server processor 176 may be any type of general or specific purpose processor. In some cases, multiple processors for the system server processor 176 may be utilized according to other embodiments. In fact, the one or more of the system server processor 176 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more of the system server processor 176 may be remote from the at least one system server 102, such as disposed within a remote platform like the one or more remote platforms 104 of FIGS. 1A and 1B.

The one or more processors may perform functions associated with the operation of system 100 which may include, for example, precoding of antenna gain/phase parameters, encoding and decoding of individual bits forming a communication message, formatting of information, and overall control of the one or more computing platforms 102, including processes related to management of communication resources.

In some embodiments, one or more computing platforms 102 may also include or be coupled to one or more antennas (not shown) for transmitting and receiving signals and/or data to and from the at least one system server 102. The one or more antennas may be configured to communicate via, for example, a plurality of radio interfaces that may be coupled to the one or more antennas. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

With renewed reference to FIGS. 1A and 1B, and as described hereinabove, the system server memory 174 stores the plurality of modules including the machine-readable instructions 105, which may be provided as tangible, non-transitory processor executable instructions, as a non-limiting example. The instructions are configured to execute the method 200 of the present disclosure, by the system server processor 176 or the other processors of the system 100 as detailed herein, and as described hereinbelow and shown in FIGS. 2A to 2D.

Referring now to FIGS. 2A to 2D, the method 200 of the present disclosure may further include a first step 202 of providing the system 100 as described hereinabove. In operation, the method 200 also includes a second step 204 of receiving, by the zero layer data gathering module 108 of the at least one system server 102 from the seller device 134, the zero party dataset and the nomination dataset. In a third step 206, the method then includes creating, by the zero layer creation module 110 of the at least one system server 102, a zero layer dataset based on the zero party dataset. In particular, the zero layer dataset represents an identity archetype of the seller.

Next, the method 200 includes a fourth step 208 of communicating, by the first layer nominating module 112 of the at least one system server 102 to the peer device 138, the nomination request. The nomination request is used for at least one nominated peer of the plurality of peers of the seller. The nomination request may include a communication to the at least one nominated peer asking for an acceptance of the nomination request. The acceptance of the nomination request may then be included in a first layer dataset, which represents the nuclear network of the seller.

As shown in FIG. 2A, the method 200 of the present disclosure may then include a fifth step 210 of receiving, by the first layer data gathering module 114 of the at least one system server 102 from the peer device 138, the acceptance of the nomination request. As mentioned above, the acceptance of the nomination request is provided by the at least one nominated peer of the plurality of peers, which advantageously allows the peers to control whether or not they are to be included in the nuclear network of the seller. The at least one nominated peer then becomes and is considered an at least one accepted peer under the system 100 upon receipt of the acceptance.

Subsequently, the method 200 as shown in FIG. 2B further includes a sixth step 212 of creating, by the first layer creation module 116 of the at least one system server 102, the first layer dataset. The first layer dataset includes an identification of the at least one accepted peer.

In a seventh step 214, as shown in FIG. 2C, the method 200 may further include analyzing, by the zero layer data analysis module 118 of the at least one system server 102, the zero layer dataset. The analysis of the zero layer dataset results in provision of an analyzed zero layer dataset. Similarly, in an eighth step 216, the method 200 may further include analyzing, by the first layer data analysis module 120 of the at least one system server 102, the first layer dataset. The analysis of the first layer dataset results in provision of an analyzed first layer dataset.

Following the analysis, in a ninth step 218 the method 200 may further include a generating, by the criteria derivation module 122 of the at least one system server 102, an anonymized search criteria dataset and a value list dataset of the seller from the analyzed zero layer dataset and the analyzed first layer dataset. Advantageously, this permits for the at least one accepted peer of the plurality of peers in the first layer dataset that meet a predetermined alignment threshold for the seller to be selected on a basis of the anonymized search criteria dataset and the value list dataset. As a non-limiting example, the predetermined alignment threshold may be a percentage alignment preselected by the seller. In one example, the predetermined alignment threshold may be at least eighty percent (e.g., 80%). One of ordinary skill in the art may also select other suitable percentages for the predetermined alignment threshold, as desired.

Referring now to FIG. 2D, the method 200 may further include as a tenth step 220 then permits for a creating, by the authorized programmatic product creation module 124 of the at least one system server 102 an authorized programmatic product. The authorized programmatic product is created from the anonymized search criteria dataset and the value list dataset. The authorized programmatic product importantly represents a packaged audience reach that is enriched through the selection of the at least one accepted peer of the plurality of peers that meets the predetermined alignment threshold for the buyer, for example, as set forth hereinabove.

The method 200 in an eleventh step 222 may include a permitting, by the communication agreement and message forms module 126 of the at least one system server 102, the seller to at least one of authorize, amend, and add terms of messages and forms of communication to be specified in the authorized programmatic product. Importantly, this allows for the seller to maintain agency over their right of publicity, as well as control over specific networks of contacts affiliated with the seller.

The method 200 may then further include a twelfth step 224, as shown in FIG. 2D, which involves receiving, by the order placement module 128 of the at least one system server 102 from the buyer device 136, the authorized programmatic product order. Then, in a thirteenth step 226, the method 200 may further include a transmitting, by the order placement module 128 of the at least one system server 102, to the buyer device 136 the authorized programmatic product order. It should be appreciated that the buyer is thereby provided with the authorized programmatic product, which represents the nuclear network of the seller. As described herein, the authorized programmatic product may also be limited according to the terms of the messages and the forms of communication specified by the seller.

In some cases, the plurality of modules of the at least one system server 102 may further include a second layer data gathering module 178, a second layer creation module 180, and a second layer dataset analysis module 182. One of ordinary skill in the art may also select other suitable modules for use with the at least one system server 102 of the present disclosure, as desired.

In such cases where the plurality of modules of the at least one system server 102 further includes the second layer data gathering module 178, the second layer creation module 180, and the second layer dataset analysis module 182, for example, as shown in FIG. 2C, the method 200 may also include an additional step 228 of receiving, by the second layer data gathering module 178 of the at least one system server 102 from the at least one third party server 140, at least one third party dataset. The method 200 may also include a next step 230 of creating, by the second layer creation module 180 of the at least one system server 102, a second layer dataset. The second layer dataset may be based on the at least one third party dataset. Importantly, the second layer dataset may represent at least one cohort of an extended network of the seller. The at least one cohort is an individual aligned with the seller but not one of the plurality of peers of the seller, as described herein.

In some cases, the individual or the cohort aligned with the seller, but which is not one of the plurality of peers of the seller, may be an influencer. Likewise, the at least one third party server 140 may be a social media platform server. It should be appreciated that the social media platform server may be access through an API intersection that is accepted by the social media platform server that uniquely allows for the analysis of the second layer dataset, which may then be used together with the analyzed zero layer dataset and the analyzed first layer dataset, in the step 218 of generating the anonymized search criteria dataset and the value list dataset of the seller.

As shown in FIG. 2C, the method 200 may also include a further step 232 of analyzing, by the second layer dataset analysis module 182 of the at least one system server 102, the second layer dataset. The analysis provides an analyzed second layer dataset. The method 200 may then proceed forward with a combination of the analyzed zero layer dataset, the analyzed first layer dataset, and the analyzed second layer dataset, resulting in the step 220 of creating the authorized programmatic product as discussed further hereinabove.

In some cases, the step 218 of selecting, on the basis of the anonymized search criteria dataset and the value list dataset, the at least one accepted peer of the plurality of peers in the first layer dataset that meet the predetermined alignment threshold for the value list dataset of the seller may further include a selecting on the basis of the anonymized search criteria dataset and the value list dataset the at least one cohort in the second layer dataset that also meet the predetermined alignment threshold for the seller.

In further cases, the step 204 of receiving the zero party dataset by the at least one system server 102 may also include a step of permitting the seller, by the seller device 134 in communication with the at least one system server 102, to identify a plurality of individuals selected from a group consisting of personal contacts, family, friends, business colleagues, casual acquaintances, known supporters, companions, individuals generally associated with the seller, and combinations thereof, as the plurality of peers proposed by the seller in the nomination dataset of the zero party dataset as forming the nuclear network of the seller.

In such cases, it should also be appreciated that the step 214 of analyzing the zero layer dataset to provide the analyzed zero layer dataset may include a retrieving of the descriptions and the biographies of the plurality of peers from the zero layer dataset. Likewise, the step 214 may include the making of a determination of value system alignment between the seller and the plurality of peers based on the descriptions and the biographies of the plurality of peers and the seller-determined criteria dataset representing the value system of the seller.

In yet additional cases, the plurality of modules of the at least one system server 102 may include the artificial intelligence module 130, and the step 214 of analyzing the zero layer dataset and the determination of the value system alignment may be completed with the artificial intelligence module 130. As non-limiting examples, the artificial intelligence module 130 may include at least one artificial intelligence process, a cyclical supervised machine learning process, a cyclical unsupervised machine learning process, and a Saaty Analytic Hierarchy process (AHP). One of skill in the art may also select other suitable artificial intelligence or machine learning processes for the artificial intelligence module 130 within the scope of the present disclosure.

In even more cases, it should be appreciated that the in the eleventh step 222 of the method 200, the communication agreement and message forms module 126 may also be configured to permit the seller to selectively authorize each of i i) a relay of datasets and types of communications through the system, ii) a reach of the first layer dataset and the second layer dataset, and iii) a budget for the creating of the authorized programmatic product. This example is consistent with the superior level of control provided to the seller over their own right of publicity under the system 100 and the method 200 as described herein.

Although the present disclosure is described primarily with respect to the system 100 and method 200, it should be appreciated that, being computer-implemented in scope, the system and method both also have a non-transient computer-readable storage medium in the form of the at least one memory 174 of the system server 102, comprising the instructions being executable by the one or more processors 176 to perform the method 200 as described herein.

### EXAMPLE

Exemplary embodiments of the present technology are provided with particular reference to the FIGS. 3-5 enclosed herewith, together with the following remarks. Introduction:

The “authorized programmatic” system and method aims to address the deficiencies associated with traditional methods of promotion, which have relied on direct engagement or influencer-based models emulating the likeness of targeted talent. While these approaches can be effective, they lack the scalability and nuanced targeting capabilities to fully capitalize on the true network effects surrounding a talent.

The authorized programmatic system and method allows for a more dynamic and layered promotion strategy. Brands can engage not just with the Source (Layer 0/Source) but also with a Nuclear Network (Layer 1) of individuals nominated by the talent, as well as a wider or extended network (Layer 2) of individuals and influencers identified through influencer management platforms, for example, as shown in FIG. 3.

Advantageously, the system and method of the present disclosure combines first-party information gathered during onboarding from Layer 0 and Layer 1 to form a set of search criteria. Anonymized search criteria and values are then used to retrieve the most aligned individuals from Layer 2. This creates a rich pool of candidates for relaying intended messages and deliverables.

In other words, the authorized programmatic system and method represents a paradigm shift in how talents and brands can harness the power of layered networks to magnify their reach and engagement. The system and method of the present disclosure allows for the relay of communication to a combined reach of Level-0, Level-1, and Level-2 audiences. In turn, this provides for a particularly versatile and efficient approach to modern brand promotion.

### Description

1) Data Gathering from Layer-0

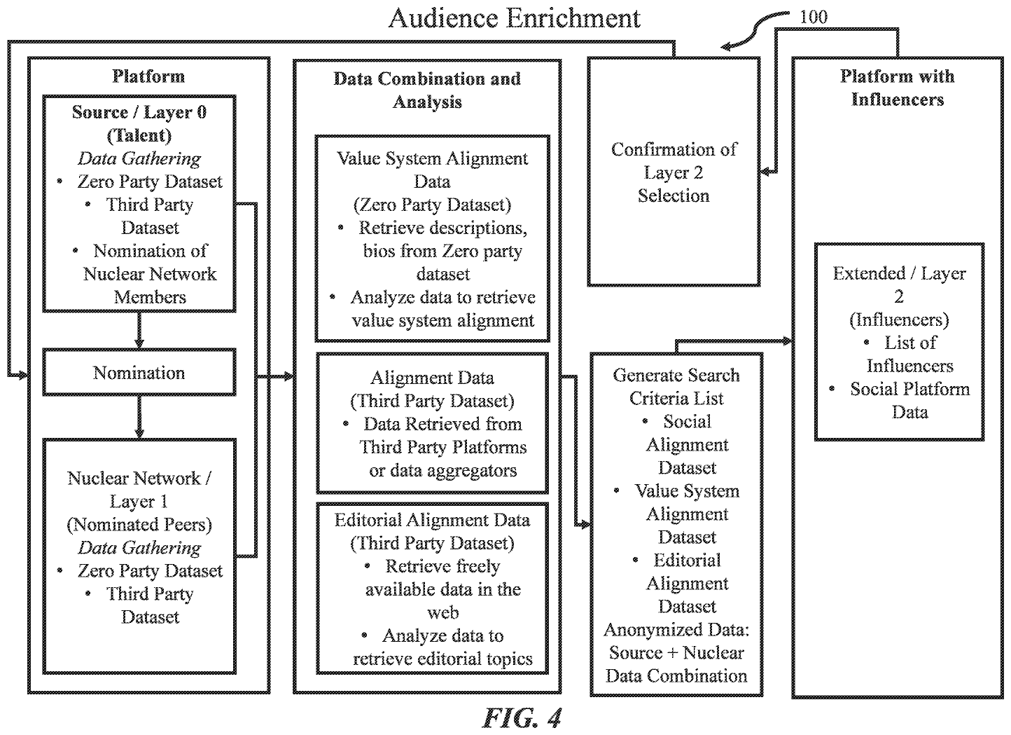

As shown in FIG. 4, the system and method enable talents, referred to as Layer-0, to submit their data. This data is essential for the system to perform its core functionalities, such as creating the Nuclear Network (Layer-1).

### 2) Nomination of Layer-1 by Layer-0

With further reference to FIG. 4, the talents in Layer-0 have the ability to nominate individuals to be part of Layer-1. The system and method enable the nomination process, including the criteria used for nomination.

3) Data Gathering from Layer-1

Once individuals accept their nomination to be part of Layer-1, the system and method gathers essential data from these nominated individuals, as depicted in FIG. 4. This data is used for various downstream activities including, but not limited to, generating search criteria for Layer-2 selection.

### 4) Data Analysis and Criteria Derivation

The system and method are also designed to analyze the data from both Layer-0 and Layer-1. Based on this analysis, the system and method generate anonymized search criteria and a value list that serves as the basis for the selection of aligned Layer-1 members.

### 5) Authorized Programmatic Product Creation

Based on the data and criteria derived, the system and method as shown in FIG. 4 creates the authorized programmatic product. The product can be described as a packaged audience reach that is enriched through the selected members of Layer-1 and Layer-2. This product is available for purchase within the system.

### 6) Communication Agreement and Message Forms

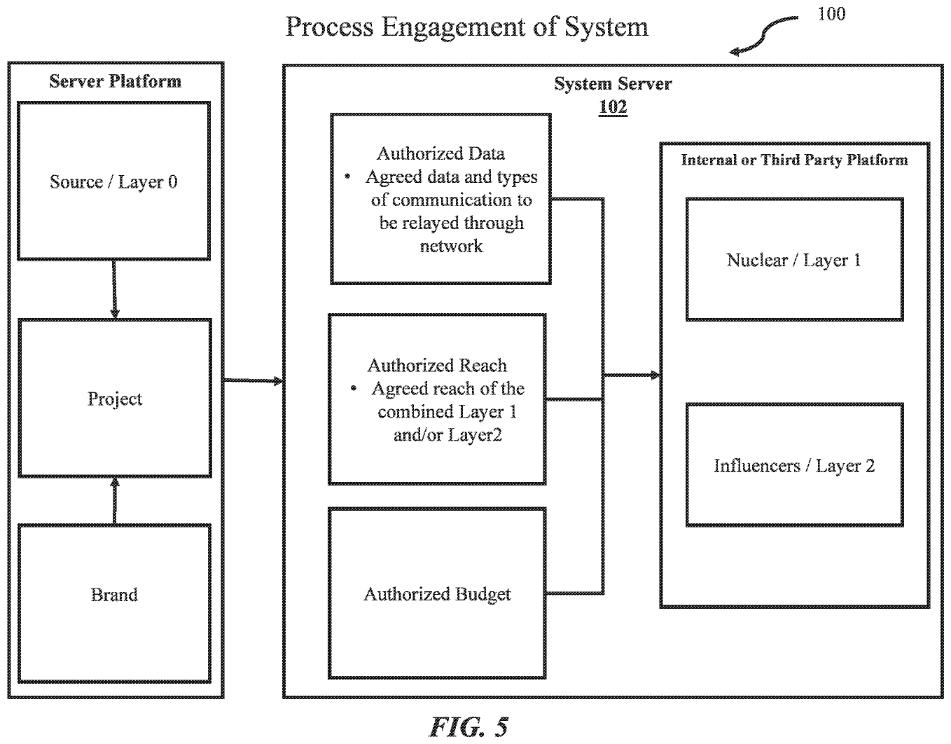

Referring to FIGS. 4 and 5, the system and method allows for the terms of the messages and the forms of communication to be specified in the authorized programmatic product. These terms can be amended or added after the initial purchase. The system and method also allow for the talent to control process engagement and to authorize data and types of communication to be related through the system, as well as the agreed reach of the combined layers, and also an authorized budget for the creation of the authorized programmatic product, as shown in FIG. 5

### 7) Order Placement

Returning to FIG. 4, upon agreement on the terms and conditions, an order for the authorized programmatic product can be placed within the system by using the method. The system and method are designed to facilitate this transaction.

### 8) Distributed Platform Functionality

While the system can exist as a standalone platform, its functionality may also be distributed across multiple platforms, potentially integrating with third-party service or information platforms.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method for dynamic and layered promotion, the method comprising steps of:
providing a layered promotion model system having a seller device having a seller device human interface, a seller device memory, a seller device processor, and a seller device display, the seller device human interface configured for use by a seller and for providing a zero party dataset, the zero party dataset including a seller-determined criteria dataset representing a value system of the seller, and a nomination dataset representing a plurality of peers proposed by a seller as forming a nuclear network of the seller and including at least one of descriptions and biographies associated with each of the plurality of peers,
a buyer device having a buyer device human interface, a buyer device memory, a buyer device processor, and a buyer device display, the buyer device human interface configured for use by a buyer and for placing an authorized programmatic product order,
a peer device having a peer device human interface, a peer device memory, a peer device processor, and a peer device display, the peer device human interface configured for use by at least one nominated peer and for accepting a nomination request to be included in the nomination dataset, and
at least one system server having a system server memory and a system server processor, the at least one system server in communication with the seller device, the buyer device, the peer device, and at least one third party server through a wide area network, the at least one third party server having at least one third party dataset, the system server memory storing a plurality of modules including tangible, non-transitory processor executable instructions, the plurality of modules including a zero layer data gathering module, a zero layer creation module, a first layer nominating module, a first layer data gathering module, a first layer creation module, a zero layer data analysis module, at least one first layer data analysis module, at least one criteria derivation module, an authorized programmatic product creation module, a communication agreement and message forms module, and an order placement module;
receiving, by the zero layer data gathering module of the at least one system server from the seller device, the zero party dataset and the nomination dataset;
creating, by the zero layer creation module of the at least one system server, a zero layer dataset based on the zero party dataset, the zero layer dataset representing an identity archetype of the seller;
communicating, by the first layer nominating module of the at least one system server to the peer device, the nomination request for at least one nominated peer of the plurality of peers, the nomination request including a communication to the at least one nominated peer asking for an acceptance of the nomination request to be included in a first layer dataset representing the nuclear network of the seller;
receiving, by the first layer data gathering module of the at least one system server from the peer device, the acceptance of the nomination request by the at least one nominated peer of the plurality of peers, the at least one nominated peer becoming an at least one accepted peer upon receipt of the acceptance;
creating, by the first layer creation module of the at least one system server, the first layer dataset including an identification of the at least one accepted peer;
analyzing, by the zero layer data analysis module of the at least one system server, the zero layer dataset to provide an analyzed zero layer dataset;
analyzing, by the first layer data analysis module of the at least one system server, the first layer dataset to provide an analyzed first layer dataset;
generating, by the criteria derivation module of the at least one system server from the analyzed zero layer dataset and the analyzed first layer dataset, an anonymized search criteria dataset and a value list dataset of the seller and selecting on a basis of the anonymized search criteria dataset and the value list dataset the at least one accepted peer of the plurality of peers in the first layer dataset that meet a predetermined alignment threshold for the seller;
creating, by the authorized programmatic product creation module of the at least one system server from the anonymized search criteria dataset and the value list dataset, an authorized programmatic product, the authorized programmatic product representing a packaged audience reach that is enriched through a selection of the at least one accepted peer of the plurality of peers that meets the predetermined alignment threshold for the buyer;
permitting, by the communication agreement and message forms module of the at least one system server, the seller to at least one of authorize, amend, and add terms of messages and forms of communication to be specified in the authorized programmatic product;
receiving, by the order placement module of the at least one system server from the buyer device, the authorized programmatic product order; and
transmitting, by the order placement module of the at least one system server, to the buyer device the authorized programmatic product order, whereby the buyer is provided with the authorized programmatic product representing the nuclear network of the seller and limited according to the terms of the messages and the forms of communication specified by the seller.

2. The method of claim 1, wherein the plurality of modules of the at least one system server further includes a second layer data gathering module, a second layer creation module, and a second layer dataset analysis module, and the method further includes a step of receiving, by the second layer data gathering module of the at least one system server from the at least one third party server, at least one third party dataset.

3. The method of claim 2, wherein the method further includes a step of creating, by the second layer creation module of the at least one system server, a second layer dataset based on the at least one third party dataset, the second layer dataset representative of at least one cohort of an extended network of the seller, the at least one cohort being an individual aligned with the seller but not one of the plurality of peers of the seller.

4. The method of claim 3, wherein the method further includes a step of analyzing, by the second layer dataset analysis module of the at least one system server, the second layer dataset to provide an analyzed second layer dataset.

5. The method of claim 4, wherein the at least one cohort is an influencer.

6. The method of claim 5, wherein the at least one third party server is a social media platform server.

7. The method of claim 6, wherein the analyzed second layer dataset is used together with the analyzed zero layer dataset and the analyzed first layer dataset in the step of generating the anonymized search criteria dataset and the value list dataset of the seller.

8. The method of claim 7, wherein the step of selecting, on the basis of the anonymized search criteria dataset and the value list dataset, the at least one accepted peer of the plurality of peers in the first layer dataset that meet the predetermined alignment threshold for the value list dataset of the seller further includes a step of also selecting on the basis of the anonymized search criteria dataset and the value list dataset the at least one cohort in the second layer dataset that also meet the predetermined alignment threshold for the seller.

9. The method of claim 8, wherein the step of receiving the zero party dataset by the at least one system server further includes a step of permitting, by the seller device in communication with the at least one system server, the seller to identify a plurality of individuals selected from a group consisting of personal contacts, family, friends, business colleagues, casual acquaintances, known supporters, companions, individuals generally associated with the seller, and combinations thereof, as the plurality of peers proposed by the seller in the nomination dataset of the zero party dataset as forming the nuclear network of the seller.

10. The method of claim 9, wherein the step of analyzing the zero layer dataset to provide the analyzed zero layer dataset includes retrieving the at least one of the descriptions and the biographies of the plurality of peers from the zero layer dataset and making a determination of value system alignment between the seller and the plurality of peers based on the descriptions and the biographies of the plurality of peers and the seller-determined criteria dataset representing the value system of the seller.

11. The method of claim 10, wherein the plurality of modules of the at least one system server includes an artificial intelligence module, and the step of analyzing the zero layer dataset and the determination of the value system alignment is completed with the artificial intelligence module.

12. The method of claim 11, wherein the artificial intelligence module is a supervised artificial intelligence process.

13. The method of claim 11, wherein the artificial intelligence module includes an unsupervised artificial intelligence process.

14. The method of claim 11, wherein the artificial intelligence module includes a Saaty analytical hierarchy process.

15. The method of claim 11, wherein the step of selecting, on the basis of the anonymized search criteria dataset and the value list dataset, the at least one accepted peer of the plurality of peers in the first layer dataset that meet the predetermined alignment threshold for the value list dataset of the seller further includes a step of also selecting, on the basis of the anonymized search criteria dataset and the value list dataset, the at least one cohort in the second layer dataset that also meet the predetermined alignment threshold for the seller.

16. The method of claim 1, wherein the step of permitting the seller to at least one of authorize, amend, and add terms of messages and forms of communication to be specified in the authorized programmatic product further includes permitting the seller, by the communication agreement and message forms module of the at least one system server, to at least one of amend and add the terms and the forms to be specified in the authorized programmatic product after the step of transmitting, by the order placement module of the at least one system server, to the buyer device the authorized programmatic product order.

17. The method of claim 1, wherein the at least one system server is provided as either a standalone system or a distributed system with the steps distributed across more than one platform.

18. The method of claim 3, further comprising a step of permitting, by the at least one system server, the seller to selectively authorize each of i) a relay of datasets and types of communications through the layered promotion model system, ii) a reach of the first layer dataset and the second layer dataset, and iii) a budget for creation of the authorized programmatic product.

19. A system for dynamic and layered promotion, comprising:
a layered promotion model system having
a seller device having a seller device human interface, a seller device memory, a seller device processor, and a seller device display, the seller device human interface configured for use by a seller and for providing a zero party dataset, the zero party dataset including a seller-determined criteria dataset representing a value system of the seller, and a nomination dataset representing a plurality of peers proposed by a seller as forming a nuclear network of the seller and including at least one of descriptions and biographies associated with each of the plurality of peers,
a buyer device having a buyer device human interface, a buyer device memory, a buyer device processor, and a buyer device display, the buyer device human interface configured for use by a buyer and for placing an authorized programmatic product order,
a peer device having a peer device human interface, a peer device memory, a peer device processor, and a peer device display, the peer device human interface configured for use by at least one nominated peer and for accepting a nomination request to be included in the nomination dataset, and
at least one system server having a system server memory and a system server processor, the at least one system server in communication with the seller device, the buyer device, the peer device, and at least one third party server through a wide area network, the at least one third party server having at least one third party dataset, the system server memory storing a plurality of modules including tangible, non-transitory processor executable instructions, the plurality of modules including a zero layer data gathering module, a zero layer creation module, a first layer nominating module, a first layer data gathering module, a first layer creation module, a zero layer data analysis module, at least one first layer data analysis module, at least one criteria derivation module, an authorized programmatic product creation module, a communication agreement and message forms module, and an order placement module,
wherein the layered promotion model system is configured by machine-readable instructions executed by at least one of the seller device processor, the buyer device processor, the peer device processor, and the system server processor to
receive, by the zero layer data gathering module of the at least one system server from the seller device, the zero party dataset and the nomination dataset;
create, by the zero layer creation module of the at least one system server, a zero layer dataset based on the zero party dataset, the zero layer dataset representing an identity archetype of the seller;
communicate, by the first layer nominating module of the at least one system server to the peer device, the nomination request for at least one nominated peer of the plurality of peers, the nomination request including a communication to the at least one nominated peer asking for an acceptance of the nomination request to be included in a first layer dataset representing the nuclear network of the seller;
receive, by the first layer data gathering module of the at least one system server from the peer device, the acceptance of the nomination request by the at least one nominated peer of the plurality of peers, the at least one nominated peer becoming an at least one accepted peer upon receipt of the acceptance;
create, by the first layer creation module of the at least one system server, the first layer dataset including an identification of the at least one accepted peer;
analyze, by the zero layer data analysis module of the at least one system server, the zero layer dataset to provide an analyzed zero layer dataset;
analyze, by the first layer data analysis module of the at least one system server, the first layer dataset to provide an analyzed first layer dataset;
generate, by the criteria derivation module of the at least one system server from the analyzed zero layer dataset and the analyzed first layer dataset, an anonymized search criteria dataset and a value list dataset of the seller and selecting on a basis of the anonymized search criteria dataset and the value list dataset the at least one accepted peer of the plurality of peers in the first layer dataset that meet a predetermined alignment threshold for the seller;
create, by the authorized programmatic product creation module of the at least one system server from the anonymized search criteria dataset and the value list dataset, an authorized programmatic product, the authorized programmatic product representing a packaged audience reach that is enriched through a selection of the at least one accepted peer of the plurality of peers that meets the predetermined alignment threshold for the buyer;
permit, by the communication agreement and message forms module of the at least one system server, the seller to at least one of authorize, amend, and add terms of messages and forms of communication to be specified in the authorized programmatic product;
receive, by the order placement module of the at least one system server from the buyer device, the authorized programmatic product order; and
transmit, by the order placement module of the at least one system server to the buyer device, the authorized programmatic product order, whereby the buyer is provided with the authorized programmatic product representing the nuclear network of the seller and limited according to the terms of the messages and the forms of communication specified by the seller.

20. A non-transient computer-readable storage medium comprising instructions being executable by one or more processors to perform a method, the method comprising steps of:
providing a layered promotion model system having
a seller device having a seller device human interface, a seller device memory, a seller device processor, and a seller device display, the seller device human interface configured for use by a seller and for providing a zero party dataset, the zero party dataset including a seller-determined criteria dataset representing a value system of the seller, and a nomination dataset representing a plurality of peers proposed by a seller as forming a nuclear network of the seller and including at least one of descriptions and biographies associated with each of the plurality of peers,
a buyer device having a buyer device human interface, a buyer device memory, a buyer device processor, and a buyer device display, the buyer device human interface configured for use by a buyer and for placing an authorized programmatic product order,
a peer device having a peer device human interface, a peer device memory, a peer device processor, and a peer device display, the peer device human interface configured for use by at least one nominated peer and for accepting a nomination request to be included in the nomination dataset, and
at least one system server having a system server memory and a system server processor, the at least one system server in communication with the seller device, the buyer device, the peer device, and at least one third party server through a wide area network, the at least one third party server having at least one third party dataset, the system server memory storing a plurality of modules including tangible, non-transitory processor executable instructions, the plurality of modules including a zero layer data gathering module, a zero layer creation module, a first layer nominating module, a first layer data gathering module, a first layer creation module, a zero layer data analysis module, at least one first layer data analysis module, at least one criteria derivation module, an authorized programmatic product creation module, a communication agreement and message forms module, and an order placement module;
receiving, by the zero layer data gathering module of the at least one system server from the seller device, the zero party dataset and the nomination dataset;
creating, by the zero layer creation module of the at least one system server, a zero layer dataset based on the zero party dataset, the zero layer dataset representing an identity archetype of the seller;
communicating, by the first layer nominating module of the at least one system server to the peer device, the nomination request for at least one nominated peer of the plurality of peers, the nomination request including a communication to the at least one nominated peer asking for an acceptance of the nomination request to be included in a first layer dataset representing the nuclear network of the seller;
receiving, by the first layer data gathering module of the at least one system server from the peer device, the acceptance of the nomination request by the at least one nominated peer of the plurality of peers, the at least one nominated peer becoming an at least one accepted peer upon receipt of the acceptance;
creating, by the first layer creation module of the at least one system server, the first layer dataset including an identification of the at least one accepted peer;
analyzing, by the zero layer data analysis module of the at least one system server, the zero layer dataset to provide an analyzed zero layer dataset;
analyzing, by the first layer data analysis module of the at least one system server, the first layer dataset to provide an analyzed first layer dataset;
generating, by the criteria derivation module of the at least one system server from the analyzed zero layer dataset and the analyzed first layer dataset, an anonymized search criteria dataset and a value list dataset of the seller and selecting on a basis of the anonymized search criteria dataset and the value list dataset the at least one accepted peer of the plurality of peers in the first layer dataset that meet a predetermined alignment threshold for the seller;
creating, by the authorized programmatic product creation module of the at least one system server from the anonymized search criteria dataset and the value list dataset, an authorized programmatic product, the authorized programmatic product representing a packaged audience reach that is enriched through a selection of the at least one accepted peer of the plurality of peers that meets the predetermined alignment threshold for the buyer;
permitting, by the communication agreement and message forms module of the at least one system server, the seller to at least one of authorize, amend, and add terms of messages and forms of communication to be specified in the authorized programmatic product;
receiving, by the order placement module of the at least one system server from the buyer device, the authorized programmatic product order; and
transmitting, by the order placement module of the at least one system server to the buyer device, the authorized programmatic product order, whereby the buyer is provided with the authorized programmatic product representing the nuclear network of the seller and limited according to the terms of the messages and the forms of communication specified by the seller.
